(19) United States
(12) Patent Application Publication
(10) Pub. No.: US 2012/0137987 A1
(43) Pub. Date: Jun. 7, 2012

(54) DEVICE FOR MAKING AN AREA OFF-LIMITS TO A PET, AND METHOD FOR IMPLEMENTING SUCH A DEVICE

(75) Inventor: Jean Moulin, Clermont Ferrand (FR)

(73) Assignee: DYNAVET, Clermont-Ferrand (FR)

(21) Appl. No.: 13/381,416

(22) PCT Filed: Jun. 25, 2010
(86) PCT No.: PCT/FR10/51321

§ 371 Date: Feb. 23, 2012

(30) Foreign Application Priority Data
Jul. 2, 2009 (FR) 09/03248

(51) Int. Cl. A01K 15/04; A01K 15/02

(52) U.S. Cl. 119/719; 119/721

(57) ABSTRACT

A device (1) for making an area (12) off-limits to a pet (2), includes a detection element (3, 10) for detecting the approach of a pet to the off-limits area and an element (5) for emitting at least one stimulus (6, 7) indicating to the pet that it is approaching the off-limits area (12). The detection element (3, 10) includes a first transceiver (3) worn by the pet (2), a second transceiver (10) located in the vicinity of the off-limits area (12) and at least one element (5) for emitting at least one stimulus (6, 7) and arranged in the vicinity of the off-limits area (12), wherein the second transceiver (10) is attached onto the stimulus emission element (5) and the emission of the stimulus (6, 7) is controlled by the first transceiver (3) worn by the pet (2) and activated by the second transceiver (10).

The invention relates to a device for making an area off-limits to a pet.

Pet means either domestic animals such as dogs, cats, ferrets, or farm or breeding animals such as horses, cattle or sheep.

Area means some place to be temporarily or definitely made off-limits to a pet. Such place may correspond to a surface defined by objects, such as a barrier, for instance, or plants, such as a flowerbed for instance. It can also be a piece of furniture or an object, such as a bed for instance, or a chair, or a knickknack. This area may not be defined by an object, it may be an access road for instance.

In order to prevent an pet from entering an off-limits area, devices are already known such as the one disclosed by WO-A-00/75046, wherein a deterrent spray is provided with a presence detector. Such deterrent spray is positioned in the vicinity of the off-limits area. The presence detector triggers the emission of a jet or spray when an pet comes near. The spray is a stimulus indicating to the pet that this area is off-limits. Such device can easily be moved from one area to another one, but does not make it possible to make a distinction between an pet authorized to enter the area and an pet which the area is prohibited to.

From WO-A-2004/014129 is also known a device for which the user is equipped with a deterrent spray. When an pet approaches the off-limits area, the user triggers the emission of a spray causing a stimulation indicating the pet that this area is off-limits. Such a device requires the user to be present in the vicinity of the off-limits area when the pet approaches the area and it can be triggered manually only.

From U.S. Pat. No. 5,872,516 is also known a device including a boundary mark positioned in the vicinity of the off-limits area. An pet wears a means emitting a stimulus, i.e. an electric shock, and a means communicating with the boundary mark. When the pet approaches the boundary mark, the collar of the pet receives the instruction of emitting the stimulus.

US-A-2001/042522 discloses a device worn by an pet. Such device includes a means emitting a punishment, more particularly an electric shock. A control unit emits a magnetic field around a given area. Such unit detects that the pet is approaching and gives the instruction of punishment. Both devices imply that the stimulus emission means is worn by the pet, which can be implemented with difficulty for a small pet.

The invention more particularly aims at remedying such drawbacks by providing an easily implemented device for making an area off-limits to a pet, which can be worn by the pet, whatever its size, which is movable and does not require the presence of the user.

For this purpose, the invention aims at providing a device for making an area off-limits to a pet, comprising a means for detecting the approach of an pet to the off-limits area and means for emitting at least one stimulus indicating to the pet that it is approaching the off-limits area, characterized in that

the detection means includes a first transceiver worn by the pet and a second transceiver located in the vicinity of the off-limits area and in that at least one means for emitting at least one stimulus is arranged in the vicinity of the off-limits area, with the second transceiver being attached onto the stimulus emission means and the emission of the stimulus being controlled by the first transceiver worn by the pet and activated by the second transceiver.

As the pet itself triggers the stimulus and as the origin of the latter is located in the vicinity of the off-limits area, the area can easily be authorized to an pet and off-limits to another. Besides, a transceiver is a device having sufficiently small dimensions to be worn by small pets.

According to advantageous but not compulsory aspects of the invention, the device can integrate one or more following characteristics:

The first transceiver is of the passive type.

The second transceiver is able to emit a signal which, when it is received by the first transceiver worn by the pet, activates the first transceiver, so that it can control the emission of the stimulus.

The stimulus includes at least the emission of a sound associated with another stimulus.

The stimulus includes the emission of a sound and a possibly perfumed inert gas.

The first transceiver equipping the pet controls several stimulus emission means, whether identical or not.

One stimulus emission means can be controlled by several transceivers worn by various pets.

The stimuli emitted by the same emission means vary according to the transceiver worn by the pet approaching the off-limits area.

The invention also relates to a method for implementing a device for making an area off-limits to a pet, comprising a means for detecting the approach of an pet to the off-limits area and means for emitting at least one stimulus indicating to the pet that it is approaching the off-limits area according to one of the preceding claims, characterized in that it includes at least the following steps:

a) positioning a first transceiver on an pet

b) positioning a second transceiver in the vicinity of the off-limits area adapted for activating the first transceiver when the pet approaches the off-limits area,

c) positioning in the vicinity of the off-limits area one means for emitting at least one stimulus, adapted for being controlled by the first transceiver when the pet approaches the off-limits area and when the first transceiver is activated by the second transceiver.

The invention will be better understood and other advantages thereof will appear more clearly when reading the following description of a device according to the invention, which is given purely as an example and refers to the appended drawing, wherein:

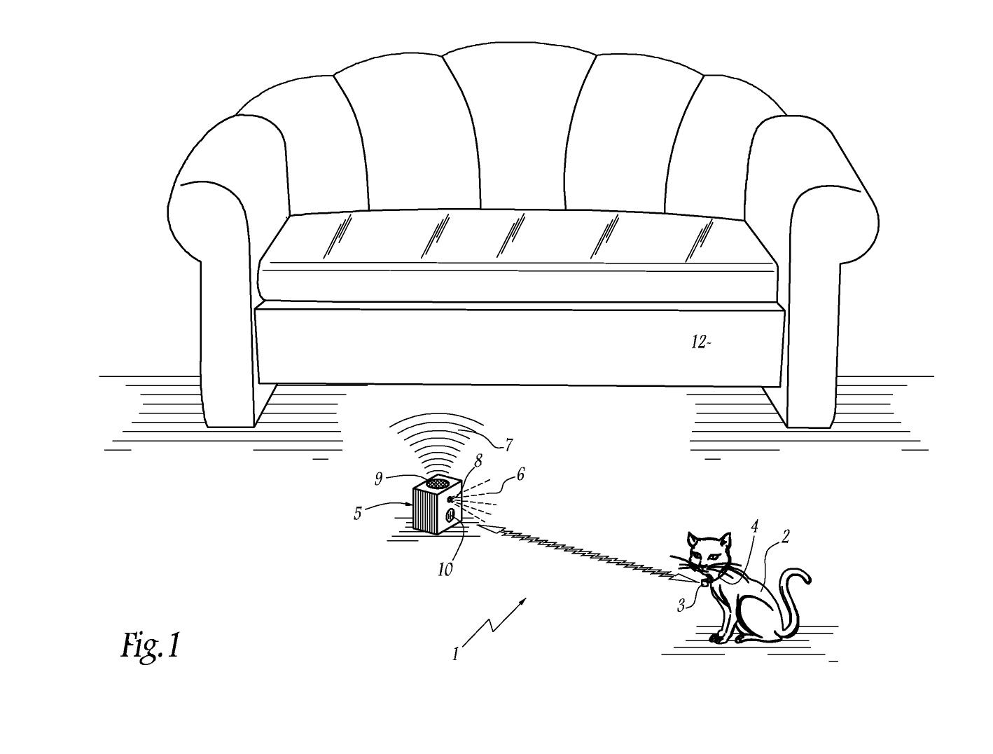

FIG. 1 is a schematic illustration of a device according to the invention, with a pet wearing a transceiver and a means for emitting a stimulus being positioned in the vicinity of an object to be off-limits. The device 1 shown in FIG. 1, is adapted for being used with various pets. Advantageously, it is intended for being used with a cat 2, as shown.

The device can also emit radiofrequencies, such as those used for radio-identification or RFID. These frequencies are for instance: 13.56 kHz, 125 kHz, 13 MHz, 869 MHz and 915 MHz.

In the case of a device of the RFID type, this can be an identification microchip positioned under the pet's skin. The pet is thus equipped with a permanent device, and the latter does not bother the pet in any way.

The device 1 includes a first transceiver 3, the dimensions of which are small enough to make it possible to be attached, in a removable or permanent way, to the collar 4 or a harness worn by the cat 2. Such transceiver 3 is light and it advantageously emits at high frequencies, i.e. 2.4 GHz. As an alternative solution, the frequencies used are different. These can be Low Frequencies, for instance.

Such emission frequency makes the utilisation possible in most countries, since this frequency is used for WiFi connections.

The device 1 also includes a means 5 emitting at least one stimulus. The stimulus may be a visual, olfactory, sensory, tactile or audio one. The means is a package 5 having a cubic shape. As an alternative solution, the shape thereof is different.

Advantageously, the means 5 may emit at least one stimulus. As a matter of fact, it emits two stimuli 6 and 7. One of the stimuli is a jet or spray 6 of an inert gas, for instance air, which may be perfumed, with citronella, for instance. Using an odorous or perfumed gas enables a user to control the correct operation of the device. The second stimulus 7 is a sound stimulus, i.e. a sound which can be heard at least by the pet. This can thus be ultrasounds.

The package 5 includes a gas tank, not shown. Such a tank has a sufficient volume to emit several successive jets 6, advantageously around 60, which corresponds to a tank of approximately 15 ml. The capacity of such a tank ranges from 2 to 250 ml.

The spray 6 is emitted by a nozzle 8 mounted on one face of the package 5. Advantageously, the nozzle 8 can be oriented.

The sound 7 is transmitted by a loudspeaker 9 attached to the package 5. The latter includes an electronic memory, not shown, wherein one or several sounds are saved. Sound means a noise, a set of noises or sounds, which are known or not to the pet, ultrasounds, a voice, words, or music.

The device 1 includes an energy power, not shown, which supplies the loudspeaker 9 and a solenoid valve attached to the gas tank. Such a source may be composed of rechargeable or not batteries and/or a transformer making it possible to connect it to the mains.

The device 1 advantageously includes a control key, not illustrated, of a type known per se. Such a control key makes it possible to select either both stimuli 6 and 7, or the sound 7, or the spray 6 when the pet 2, through a Pavlov-type reflex, associates the two stimuli. It is no longer necessary, then, to emit both stimuli together.

The package 5 may be equipped with attaching members, for example adhesive pads making it possible to hold it on various surface types, either horizontal or vertical ones. As an alternative solution, it may be mounted onto a pole to be anchored in the ground, for instance in the vicinity of a flowerbed, when it is used outdoors. As an alternative solution, it may be equipped with casters facilitating the displacement thereof.

The package 5 includes a transceiver 10. In one embodiment not shown, the transceiver 10 is independent from the package 5 and it is positioned in the vicinity of the latter and of the off-limits area 12, i.e. a couch 12. The connection between the stimuli emission means 5 and the transceiver 10 may, then be a wire or a wireless one.

Advantageously, the transceiver 10 positioned on the stimuli emission means, i.e. the package 5, is adapted for recognizing several transceivers 3 worn by various pets. In other words, if you own several pets, each one of them is provided with a transceiver 3 which triggers the emission of a stimulus 6 and/or 7, when the pet approaches the off-limits area 12. As an alternative solution, several packages 5 distributed in the vicinity of several off-limits areas make it possible to make one or several areas off-limits to one or several given pets, with the areas not being necessarily the same for the various pets.

Similarly, several transceivers 10 mounted on different packages 5, can recognize the same transceiver 3 worn by the pet 2. In other words, an pet 2 can trigger several transceivers 10, and thus control several emissions of stimuli, with the corresponding packages 5 being located in the vicinity of several off-limits areas or defining a large area.

The transceiver 3 worn by the pet 2 and the transceiver 10 attached to the package 5, are, each, equipped with a control means, which is not shown, making it possible to define a stimulus 6 or 7 triggering distance when the pet 2 approaches the off-limits area 12. In practice, such a distance must be small enough to make the pet 2 associate the approaching of the area 12 with the emission of the stimulus 6, 7 and for the stimulus to be efficient, more particularly for the spray 6 to be received by the pet. Advantageously, such a distance ranges from a few centimetres to 2 metres.

The intensity and/or duration of the spray 6 can be controlled and the sound 7 can be modulated and/or adjusted in intensity and/or duration.

The sequence of the stimuli, i.e. the alternation of sound 7 and spray 6, when they are both emitted, can vary.

The device 1 can advantageously be put in watch mode or actuated from a remote location, via a remote control, a micro-computer, the Internet or a mobile telephone network.

In this case, the owner of the pet can easily choose to actuate the device or not, without the transceiver 3 and the package 5 being removed.

It can also be controlled by wire means.

The transceiver 3 is of the passive type, i.e. it is in watch mode and emits no sound.

When an pet 2 approaches the off-limits area 12, thus the package 5, the transceiver 3 worn by the pet 2 is within the range of the transceiver 10 of the package 5. Such transceiver 10 is of the active type and it continuously or regularly emits a given signal. If the signal corresponds to a known signal from the transceiver 3, the signal is received and the transceiver 3 is actuated.

The transceiver 3 worn by the pet 2 then sends back a signal which is in turn recognized by the transceiver 10 as a signal of the emission of the stimulus or stimuli 6, 7 by the package 5, whereto the transceiver 10 is attached. Then a sound 7 and/or a spray 6 will be emitted toward the pet 2.

Using a passive transceiver 3, the implementation of which is triggered by the active transceiver 10 makes it possible to save energy since the transceiver 3 worn by the pet is inactive most of the time, and the power source thereof can thus be minimized, which makes it possible to reduce the size and weight of the transceiver 3 and to have it worn by small size pets, such as a cat 2 or a ferret. On the contrary, the transceiver 10 is provided with a higher capacity power source, since it is active most of the time.

Using the device 1 also makes it possible to make certain areas off-limits to a pet inside the house and to authorize these areas to another pet. For this purpose, the signal of a transceiver 3 must be recognized by the transceiver 10 and the transceiver 10 must not be recognized by the signal from another transceiver 3. An pet, in the first case, will thus receive a stimulus indicating that it must not approach the off-limits and, in the second case, that it can approach the same area without being punished.

As an alternative solution, an pet not wearing the transceiver 3 shall not trigger a stimulus, and will thus be authorized to enter the off-limits area 12.

Such a device thus enables to discriminate between pets.

Triggering the stimulus, i.e. activating the package 5, can also be controlled according to a parameter out of the off-limits area, for example according to the external hygrometry. An area can thus be made off-limits indoors when it is raining outdoors.

Locating the position of the pet is made possible, by triangulation, when placing several packages 5 and transceivers 10 around the off-limits area, and sending information from the transceivers to a control unit.

1. A device (1) for making an area (12) off-limits to a pet (2), comprising a means (3, 10) for detecting the approach of an pet to the off-limits area and means (5) for emitting at least one stimulus (6, 7) indicating to the pet that it is approaching the off-limits area (12), characterized in that
the means (3, 10) for detection includes a first transceiver (3) worn by the pet (2) and a second transceiver (10) located in the vicinity of the off-limits area (12)
and in that at least one means (5) for emitting at least one stimulus (6, 7) is arranged in the vicinity of the off-limits area (12), with the second transceiver (10) being attached onto the means (5) for emitting the stimulus (6, 7)and the emission of the stimulus (6, 7) being controlled by the first transceiver (3) worn by the pet (2) and activated by the second transceiver (10).

2. A device according to claim 1, characterized in that the first transceiver (3) is of the passive type.

3. A device according to claim 2, characterized in that the second transceiver (10) is able to emit a signal which, when it is received by the first transceiver (3) worn by the pet (2), activates the first transceiver (3), so that it can control the emission of the stimulus (6, 7).

4. A device according to claim 1, characterized in that the stimulus includes at least the emission of a sound (7) associated with another stimulus (6).

5. A device according to claim 4, characterized in that the stimulus includes the emission of a sound (7) and a possibly perfumed inert gas (6).

6. A device according to claim 1, characterized in that the first transceiver (3) equipping the pet (2) controls several means (5) for emitting the stimulus (6, 7), whether identical or not.

7. A device according to claim 1, characterized in that one mean (5) for emitting the stimulus (6, 7) can be controlled by several transceivers (3) worn by various pets (2).

8. A device according to claim 7, characterized in that stimuli (6, 7) emitted by the same means (5) for emitting vary according to the transceiver (3) worn by the pet (2) approaching the off-limits area (12).

9. A method for implementing a device for making an area (12) off-limits to a pet, comprising a means (3, 10) for detecting the approach of an pet to the off-limits area and means (5) for emitting at least one stimulus (6, 7) indicating to the pet that it is approaching the off-limits area (12) according to claim 1, characterized in that it includes at least the following steps:
a) positioning a first transceiver (3) on the pet (2)
b) positioning a second transceiver (10) in the vicinity of the off-limits area (12) adapted for activating the first transceiver (3) when the pet approaches the off-limits area,
c) positioning in the vicinity of the off-limits area (12) one means (5) for emitting at least one stimulus, adapted for being controlled by the first transceiver (3) when the pet approaches the off-limits area and when the first transceiver is activated by the second transceiver.

10. A device according to claim 2, characterized in that the stimulus includes at least the emission of a sound (7) associated with another stimulus (6).

11. A device according to claim 2, characterized in that the first transceiver (3) equipping the pet (2) controls several means (5) for emitting the stimulus (6, 7), whether identical or not.

12. A device according to claim 2, characterized in that one mean (5) for emitting the stimulus (6, 7) can be controlled by several transceivers (3) worn by various pets (2).

13. A device according to claim 3, characterized in that the stimulus includes at least the emission of a sound (7) associated with another stimulus (6).

14. A device according to claim 3, characterized in that the first transceiver (3) equipping the pet (2) controls several means (5) for emitting the stimulus (6, 7), whether identical or not.

15. A device according to claim 3, characterized in that one mean (5) for emitting the stimulus (6, 7) can be controlled by several transceivers (3) worn by various pets (2).
